(19) United States
(12) Patent Application Publication
(10) Pub. No.: US 2006/0099459 A1
(43) Pub. Date: May 11, 2006

(54) Information recording medium

(75) Inventors: Daisuke Yoshitoku, Tokyo (JP); Koji Mishima, Tokyo (JP); Kenji Yamaga, Tokyo (JP); Tsuyoshi Komaki, Tokyo (JP); Shigeru Yamatsu, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 10/984,965

(22) Filed: Nov. 10, 2004

(51) Int. Cl. G11B 5/66

(52) U.S. Cl. 428/824.1; 428/822.1

(57) ABSTRACT

In an information recording medium according to the present invention, a recording layer is formed so as to be sandwiched by a first resin layer and a second resin layer, and a track pitch is in a range of 0.1 μm to 0.5 μm, inclusive, wherein at least one resin layer out of the first and second resin layers has a permeability according to JIS Z0208 in a range of 1 g/m²·24 h to 250 g/m²·24 h, inclusive.

### BACKGROUND OF THE INVENTION

1. Field of the Invention

The present invention relates to an information recording medium where recording marks are recorded on a recording layer by irradiating a laser beam.

2. Description of the Related Art

As one example of this kind of information recording medium, an optical information recording medium in which a recording layer is formed on a substrate (member) and a lubricating layer is formed so as to cover the recording layer is disclosed in Japanese Laid-Open Patent Publication No. 2003-48375. In this optical information recording medium, the recording layer is formed on the substrate that is any of a polycarbonate substrate, a crystallized glass substrate, a toughened glass substrate, and an AlMg alloy substrate. The recording layer is formed as a thin film by sputtering various kinds of oxide (as one example, Bi₃Fe₅O₁₂) on the surface of the substrate. In addition, the lubricating layer is formed by applying a lubricant such as a hydrocarbon lubricant and a fluorolubricant onto the surface of the recording layer. By irradiating a laser beam onto this optical information recording medium using a recording/reproduction apparatus, regions of the recording layer that are irradiated by the laser beam heat up and are deformed or reformed so that the optical characteristics change, with such parts being recorded as recording marks.

However, by investigating this conventional optical information recording medium, the present inventors discovered the following problems. In this conventional optical information recording medium, damage to and deterioration of the recording layer are prevented by applying the lubricant so as to cover the recording layer. However, it is extremely difficult to sufficiently avoid damage to and deterioration of the recording layer using a lubricating layer with a thickness of several μm or so. This conventional optical information recording medium therefore has a problem in that there is the risk of recording/reproduction errors being caused by damage to the recording layer. In addition, since this conventional optical information recording medium is constructed so that the recording layer contacts the outside air via the extremely thin lubricating layer, when a laser beam is irradiated during the recording of recording data, heat is dissipated from the recording layer to the outside air, resulting in cases where the temperature does not rise sufficiently for deformation or reformation of the regions irradiated by the laser beam. Accordingly, with this conventional optical information recording medium, it is necessary to sufficiently irradiate a laser beam so as to reliably cause deformation or reformation of the regions irradiated by the laser beam. This means that this conventional optical information recording medium has a further problem in that it is difficult to record recording data at high-speed. To solve the above problems, a construction has been proposed where deformation or reformation of the recording layer is caused reliably by forming thin layers of dielectric material (hereinafter also referred to as “dielectric layers”) so as to sandwich the recording layer and the recording layer is protected by forming a resin layer (protective layer) so as to cover the recording layer sandwiched between the dielectric layers.

On the other hand, the present applicant has discovered that it is possible to improve the recording characteristics by leaving an information recording medium (optical disc) whose recording layer has been formed using a recording material with oxide as a main component in an environment with a predetermined temperature and humidity. More specifically, for an optical disc whose recording layer has been formed using a recording material with bismuth oxide (BiOx, which is one example of an oxide) as a main component, by leaving the disc in a high humidity environment for a predetermined time, it is possible to improve the recording characteristics, such as the C/N ratio, compared to an optical disc that has been fabricated under the same conditions using the same recording material but has subsequently not been left in the high humidity environment. However, when a recording layer formed of the recording material described above is protected by a multilayer structure where the recording layer is sandwiched by dielectric layers or by forming a thick resin layer so as to cover the recording layer, the permeation of moisture is obstructed by the dielectric layers and/or the resin layer. As a result, since moisture cannot sufficiently reach the recording layer when the medium is left in the high humidity environment, there is the problem that it is difficult to improve the recording characteristics.

### SUMMARY OF THE INVENTION

It is a principal object of the present invention to provide an information recording medium that can improve the recording characteristics while avoiding damage to the recording layer.

To achieve the stated object, an information recording medium according to the present invention is constructed so that a recording layer is formed so as to be sandwiched by a first resin layer and a second resin layer, and a track pitch is in a range of 0.1 μm to 0.5 μm, inclusive, wherein at least one resin layer out of the first and second resin layers has a permeability according to JIS Z0208 in a range of 1 g/m²·24 h to 250 g/m²·24 h, inclusive.

In this information recording medium, at least one resin layer out of the first and second resin layers is formed so that a permeability thereof according to JIS Z0208 is in a range of 1 g/m²·24 h to 250 g/m²·24 h, inclusive. For this reason, the recording layer is sufficiently protected by both resin layers and the C/N ratio can be sufficiently improved by having the recording layer reformed by moisture that permeates through the resin layer(s) whose permeability is in the range given above when the medium is left in a high humidity environment. Also, the recording layer differs to a conventional bare optical disc and when the recording layer is irradiated with a laser beam during the reproduction of recording data, the recording layer rises to a sufficient temperature for deformation or reformation, so that recording marks can be reliably formed.

Here, a construction can be used where both the first and second resin layers have permeabilities in a range of 1 g/m²·24 h to 250 g/m²·24 h, inclusive. With this construction, it is possible to have the recording layer sufficiently reformed by moisture that has permeated through both resin layers, so that the C/N ratio can be further improved.

It is also possible to form the recording layer between a support substrate made of resin as the first resin layer and a light transmitting layer as the second resin layer. The expression “support substrate” in this specification refers to a substrate that functions as a support when forming the recording layer or the like. Also, the expression “light transmitting layer” in this specification refers to a resin layer that is formed of resin material that transmits light and that is passed by a laser beam when recording data is recorded and reproduced. With this construction, compared to an optical disc with a multilayer structure where the recording layer is sandwiched by dielectric layers or the like, a sputtering apparatus for forming the dielectric layers and a process for forming the dielectric layers or the like can be made unnecessary. Accordingly, it is possible to sufficiently reduce the manufacturing cost of an information recording medium.

Also, a construction may be used where the permeabilities of both the first and second resin layers are in a range of 40 g/m²·24 h to 250 g/m²·24 h, inclusive. With this construction, the recording layer can be sufficiently reformed by moisture that has permeated through both resin layers and the C/N ratio can be improved further.

In addition, another information recording medium according to the present invention is constructed with a recording layer formed so as to be sandwiched by a support substrate made of resin as a first resin layer and a light transmitting layer as a second resin layer, a hard coat layer formed so as to cover the light transmitting layer, and a track pitch in a range of 0.1 μm to 0.5 μm, inclusive, wherein a multilayer structure composed of the light transmitting layer and the hard coat layer has a permeability according to JIS Z0208 in a range of 1 g/m²·24 h to 250 g/m²·24 h, inclusive.

In this information recording medium, a hard coat layer is formed so as to cover the light transmitting layer and a multilayer structure composed of the light transmitting layer and the hard coat layer has a permeability in a range of 1 g/m²·24 h to 250 g/m²·24 h, inclusive. For this reason, it is possible to have the hard coat layer prevent damage to the information recording medium without the permeation of moisture being obstructed by the hard coat layer that is extremely thin. Accordingly, an optical disc that has a high C/N ratio and is also resistant to damage can be provided.

Here, the recording layer may be composed of a single layer formed using a recording material with the two elements Bi and O as main components. It should be noted that the expression “a recording material with the two elements Bi and O as main components” refers to a recording material in which the proportion of the number of atoms occupied by the two elements Bi and O with respect to all of the elements composing the recording material is at least 75%, preferably at least 80%, and more preferably at least 90%. Also, the expression “a recording material with the two elements Bi and O as main components” in the present invention includes materials in which the proportions of the elements composing the recording material are somewhat different. Accordingly, a “single layer” for the present invention includes both a layer in which the proportions of the respective elements composing the recording material are the same across the entire layer and a layer including parts where the proportions of the respective elements somewhat differ to one another. With this construction, manufacturing is simple and the material cost is comparatively low, so that the manufacturing cost of an information recording medium can be sufficiently reduced. In addition, since the recording layer can be reformed by moisture that has permeated through both resin layers, it is possible to provide an information recording medium with a favorable C/N ratio.

### BRIEF DESCRIPTION OF THE DRAWINGS

These and other objects and features of the present invention will be explained in more detail below with reference to the attached drawings, wherein:

FIG. 1 is a cross-sectional view showing the construction of an optical disc; and

FIG. 2 is another cross-sectional view showing the construction of an optical disc.

### DESCRIPTION OF THE PREFERRED EMBODIMENTS

Preferred embodiments of an information recording medium according to the present invention will now be described with reference to the attached drawings.

First, the construction of an optical disc 1 will be described with reference to the drawings.

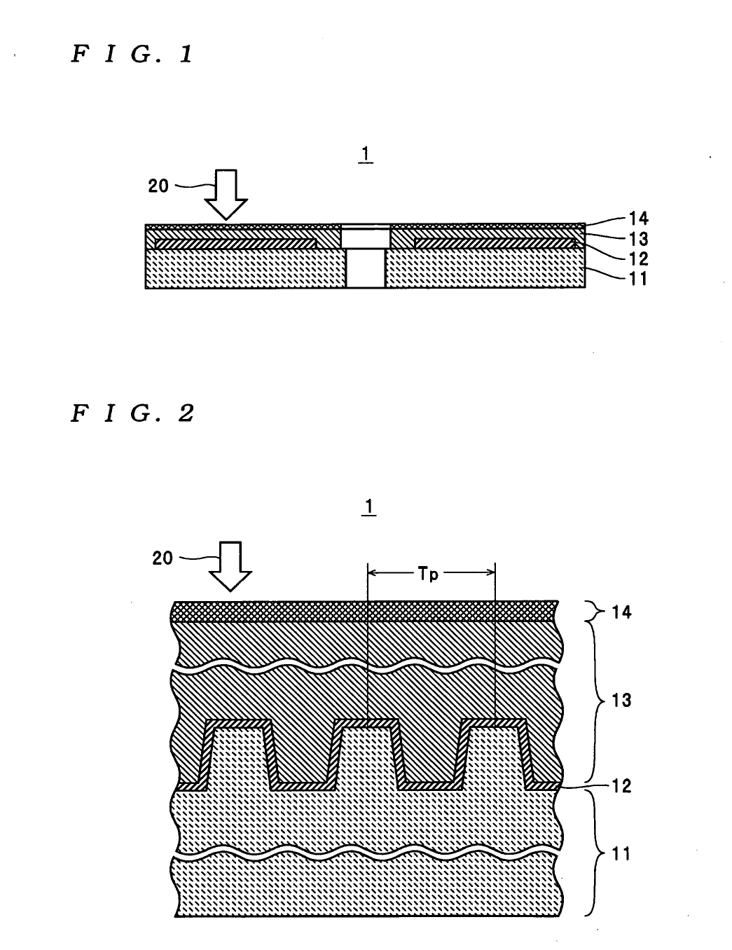

The optical disc 1 shown in FIGS. 1, 2 is a single-sided write-once information recording medium that is one example of an information recording medium according to the present invention, and is formed in a disc-like form with a diameter of around 120 mm and a thickness of around 1.2 mm. More specifically, the optical disc 1 has a recording layer 12, a light transmitting layer 13, and a hard coat layer 14 formed in that order on a disc substrate 11, and by irradiating a laser beam 20 from the light transmitting layer 13 side (from the top toward the bottom in both drawings), the recording of recording data on the recording layer 12 and the reproduction of recording data recorded on the recording layer 12 are carried out. In this case, when recording data is recorded onto or reproduced from the optical disc 1, a laser beam 20 with a wavelength in a range of around 380 nm to 450 nm, inclusive (as one example, a wavelength of 405 nm) is irradiated. Accordingly, as shown in FIG. 2, grooves and lands are formed in the disc substrate 11 during injection molding so that the track pitch TP is in a range of 0.1 μm to 0.5 μm, inclusive (as one example, 0.3 μm) and the disc is constructed so that recording data can be recorded and reproduced by a laser beam 20 of the wavelength stated above.

The disc substrate 11 corresponds to a support substrate that serves as a “first resin layer” for the present invention and is injection molded in a disc-like form with a diameter of 120 mm and a thickness of around 1.1 mm using a predetermined resin material so that the water vapor permeability according to JIS Z0208 (hereinafter simply referred to as “permeability”) is in a range of 1 g/m²·24 h to 250 g/m²·24 h, inclusive (hereinafter, a permeability in this range is also referred to as “the desired permeability”). Here, the magnitude of the permeability of the disc substrate 11 is greatly affected by the type of resin material used for molding and the thickness of the disc substrate 11 after molding. Since there is the risk of a fall in the strength of the optical disc 1, increasing the permeability by forming the disc substrate 11 excessively thinly is problematic. Accordingly, to achieve the desired permeability for the disc substrate 11, it is necessary to select a resin material that can satisfy the desired permeability even when the thickness is set at around 1.1 mm.

In this case, polycarbonate resin, acrylic resin, epoxy resin, polystyrene resin, polyethylene resin, polyolefin resin, polypropylene resin, silicone resin, fluororesin, ABS resin, urethane resin, and the like can be given as examples of the resin material used to mold the disc substrate 11. Out of these, by using polycarbonate resin, it is possible to avoid large increases in the molding cost while still being able to mold the disc substrate 11 with a sufficiently high permeability within the desired range. More specifically, as shown in Table 1 below that shows the permeability of layers (substrates) formed of various materials, the permeability of a disc substrate 11 (substrate B in the Table) formed with a thickness of 1.1 mm using polycarbonate resin is 45 g/m² 24 h. Accordingly, for the optical disc 1, the disc substrate 11 is molded using polycarbonate resin, for example.

A convex/concave pattern (groove and land) is also formed in the surface of the disc substrate 11 so that recording data can be recorded and reproduced by irradiation of a laser beam 20 whose wavelength is in a range of around 380 to 450 nm. In this case, the groove (convex part) that projects toward the side on which the laser beam 20 is irradiated (the incident side) functions as a track for recording and reading recording data on the recording layer 12. Accordingly, to make proper tracking possible, as one example the groove is formed with a height in a range of 15 nm to 25 nm, inclusive and with a track pitch between adjacent parts of the groove in a range of 0.1 μm to 0.5 μm, inclusive (as one example, 0.3 μm). It should be noted that it is also possible to have the land (the concave part) function as the track, and on such a disc substrate, the land is formed with a depth in the above range of 15 nm to 25 nm, inclusive and with a track pitch between adjacent parts of the land in the above range of 0.1 μm to 0.5 μm, inclusive. It is also possible to have both the groove and the land function as tracks, and on such a disc substrate, the groove and the land are formed so that the depth from the upper surface of the groove on the incident side for the laser beam 20 to the bottom surface of the land is formed in the above range of 15 nm to 25 nm, inclusive and the pitch between adjacent parts of the groove and the land is in the above range of 0.1 μm to 0.5 μm, inclusive.

TABLE 1

| | | | | Permeability |
|---|---|---|---|---|
| | Material | Thickness | | (g/m2 · 24 h) |
| Dielectric layers | Al₂O₃ | 10 | nm | 0.08 |
| Substrate A | APO | 1.1 | mm | 1.1 |
| Substrate B | PC | 1.1 | mm | 45 |
| Light transmitting | APO Sheet | 100 | μm | 1.8 |
| layer A | | | | |
| Light transmitting | Mixed resin | 100 | μm | 70 |
| layer B | | | | |
| Light transmitting | Mixed resin | 100 | μm | 202 |
| layer C | | | | |
| Light transmitting | Mixed resin | 100 | μm | 260 |
| layer D | | | | |

The recording layer 12 is composed of a single layer (thin film) with a thickness of around 45 nm that is formed by sputtering using a recording material that has the two elements Bi and O as main components (a recording material where the proportion of Bi and O in the entire recording material is at least 75%, preferably at least 80%, and even more preferably at least 90%). In this case, to improve the recording characteristics, the recording layer 12 of the optical disc 1 is formed so that the proportion of O atoms with respect to the total number of Bi and O atoms is in a range of 63% to 77%, inclusive. Also, the thickness of the recording layer 12 is not limited to the thickness stated above, but to obtain a reproduction signal with a sufficient level during the reproduction of recording data, the recording layer 12 should preferably be formed so that the thickness is in a range of 20 nm to 80 nm, inclusive. It should be noted that the method of forming the recording layer 12 is not limited to sputtering and it is possible to form the recording layer 12 using vapor phase epitaxy, such as vapor deposition.

The light transmitting layer 13 corresponds to a “second resin layer” for the present invention and is formed by spin coating a UV-hardening resin material with a thickness of 30 to 200 μm, inclusive (as one example, 100 μm) to achieve a desired permeability. In this case, in the same way as the disc substrate 11, the magnitude of the permeability of the light transmitting layer 13 is greatly affected by the type of resin material spin coated and the thickness of the light transmitting layer 13 after formation. In this case, since the recording layer 12 must be sufficiently protected, it is difficult to increase the permeability by forming the light transmitting layer 13 excessively thinly. Accordingly, to achieve the desired permeability for the light transmitting layer 13, it is necessary to select a resin material that can satisfy the desired permeability even when the thickness is set at around 100 μm. In this case, energy ray-hardened resins such as acrylic UV-hardening resin and epoxy UV-hardening resin can be given as examples of the resin material used for forming the light transmitting layer 13. In this optical disc 1, as one example, the light transmitting layer 13 can be constructed of a resin layer (the light transmitting layer C in Table 2 given later) so that the permeability is around 202 g/m²·24 h. It should be noted that the method of forming the light transmitting layer 13 is not limited to a method that spin coats a resin material, and the light transmitting layer 13 can be formed by sticking a resin film with the desired permeability onto the surface of the recording layer 12.

The hard coat layer 14 is formed with a thickness of around 3 μm by spin coating an equivalent resin material as is used to form the light transmitting layer 13 on the surface of the light transmitting layer 13. In this case, since the hard coat layer 14 that is around 3 μm thick has extremely high permeability (i.e., the permeation of moisture is not significantly obstructed), there is hardly any difference in permeability between a multilayer structure composed of the light transmitting layer 13 and the hard coat layer 14 and the light transmitting layer 13 by itself. This means that the situation where moisture is obstructed from reaching the recording layer 12 from the light transmitting layer 13 side by the hard coat layer 14 is avoided. It should be noted that to improve the abrasion resistance and damage resistance, as a resin material for forming the hard coat layer 14, it is preferable to use a resin material where the hardening functional groups are more polyfunctional than the resin material used for forming the light transmitting layer 13 and a resin material whose molecular weight is lower than that of the resin material used for forming the light transmitting layer 13.

Next, a method of manufacturing and a method of using the optical disc 1 will be described.

First, the disc substrate 11 is injection molded using a polycarbonate resin. Next, the recording layer 12 is formed by sputtering on the surface of the disc substrate 11 in which the convex/concave pattern (track) is formed. More specifically, the disc substrate 11 is set in a chamber (not shown) in which a Bi target has been disposed and O₂ gas is then supplied inside the chamber. Next, a sputtering gas such as Ar gas is supplied inside the chamber and collides with the Bi target. At this time, as examples, the flow rate of the O₂ gas is set at 20 sccm and the flow rate of the Ar gas is set at 50 sccm. By doing so, the Bi particles are scattered inside the chamber and the Bi accumulates on the surface of the disc substrate 11 (the surface with the convex/concave pattern) while reacting with the O₂ gas and oxidizing. As a result, the recording layer 12 composed of a single layer that is around 45 nm thick is formed on the surface of the disc substrate 11. In this case, by appropriately adjusting the sputtering conditions when the recording layer 12 is formed, it is possible to change the proportions of the Bi and O in the recording layer 12 in the various parts in the thickness direction of the recording layer 12. In addition, although it is preferable to construct the recording layer 12 mainly of Bi and O, it is also possible to include other atoms, compounds, or the like, provided that the amount of such is small. In this case, when the included amount of other atoms, compounds, or the like is too high, the relative amount of Bi and O in the recording layer 12 falls, which makes it difficult to form recording marks from which data can be read reliably. Accordingly, the included proportion of other atoms, compounds, or the like aside from Bi and O should preferably be 25% or below, and more preferably 10% or below.

Next, the substrate 11 on which the formation of the recording layer 12 has been completed is removed from the chamber and is set in a spin coating apparatus (not shown). Next, after a UV-hardening resin material for forming the light transmitting layer 13 (a mixed resin in which various resin materials are mixed) has been spin coated on the recording layer 12, UV rays or the like are irradiated to cause hardening. By doing so, the light transmitting layer 13 is formed with a thickness of around 100 μm. After this, by spin coating and then hardening a UV-hardening acrylic resin, for example, on the surface of the light transmitting layer 13, the hard coat layer 14 is formed with a thickness of around 3 μm. Next, the optical disc 1 for which the formation of the hard coat layer 14 has been completed is set and left inside a reformation processing apparatus (not shown). In this case, in the reformation processing apparatus, the temperature inside the processing chamber is maintained at around 25° C. and the relative humidity at 95% ±2%. The optical disc 1 is left in the processing chamber in this state for around seven days (168 hours). In this case, since both the disc substrate 11 and the light transmitting layer 13 in the optical disc 1 are formed so as to have the desired permeability, moisture included in the air inside the processing chamber permeates through the disc substrate 11 and the light transmitting layer 13 so that the required amount of moisture reaches the recording layer 12. Here, the surface reformation of the recording layer 12 of the optical disc 1 due to the addition of a certain amount of moisture improves the recording characteristics when the laser beam 20 is irradiated (i.e., when the recording data is recorded). Accordingly, by leaving the optical disc 1 inside a processing chamber maintained at (adjusted to) a high humidity environment for seven days, the recording layer 12 is sufficiently reformed and the recording characteristics of the recording layer 12 are improved. By doing so, the optical disc 1 shown in FIGS. 1 and 2 is completed.

When recording data is recorded and reproduced on the optical disc 1, as described above, a blue-violet laser beam 20 with a wavelength of around 405 nm is irradiated. More specifically, by irradiating a laser beam 20, whose recording power has been adjusted, from the light transmitting layer 13 side during the recording of recording data, the parts of the recording layer 12 irradiated by the laser beam 20 are heated and the optical characteristics of such parts change so that recording marks are formed. Since the surface of the recording layer 12 is covered by the light transmitting layer 13 in the optical disc 1, the situation where the heat quickly dissipates to the outside air when the recording layer 12 heats up due to the irradiation of the laser beam 20 is avoided. Also, since both the disc substrate 11 and the light transmitting layer 13 in the optical disc 1 are formed so as to have the permeabilities in a desired range and the recording layer 12 is sufficiently reformed, the recording characteristics of the recording layer 12 are sufficiently improved. Accordingly, the occurrence of recording errors is sufficiently avoided. On the other hand, when reproducing recording data, the laser beam 20 whose reproduction power has been adjusted is irradiated from the light transmitting layer 13 side and the presence of recording marks in the recording layer 12 is detected based on reflected light. By doing so, the recording data is reproduced.

Next, the relationship between the permeability of the resin layers that sandwich the recording layer 12 (the disc substrate 11 and the light transmitting layer 13 of the optical disc 1) and the improvement in the recording characteristics when the disc is left in a high humidity environment will be described.

First, optical discs that are first to fifth embodiments and optical discs that are first and second comparative examples shown in Table 2 were respectively fabricated using the various resin layers shown in Table 1 as the disc substrate 11 and the light transmitting layer 13, with the respective recording layers 12 being sandwiched between these resin layers. It should be noted that since the method of forming the recording layer 12 is the same as for the optical disc 1 described above, description thereof has been omitted. Here, the dielectric layers were formed with a thickness of around 10 nm by sputtering Al₂O₃, resulting in a permeability of 0.08 g/m²·24 h. It should be noted that regarding the permeability of the dielectric layers (Al₂O₃), the permeability was measured for a multilayer structure in which a thin film of Al₂O₃ is formed with a thickness of around 10 nm on a support substrate and the value of the permeability of the support substrate alone was subtracted from the measured value to find the permeability of the thin film of Al₂O₃ alone. Substrate A is formed of amorphous polyolefin resin with a thickness of 1.1 mm, resulting in a permeability of 1.1 g/m²·24 h. Substrate B is formed of polycarbonate resin with a thickness of 1.1 mm, resulting in a permeability of 45 g/m²24 h. Light transmitting layer A is constructed of a resin sheet formed of amorphous polyolefin resin with a thickness of 95 μm, resulting in a permeability of 1.8 g/m²·24 h. It should be noted that the light transmitting layer A was formed by sticking on a resin sheet in a state where a UV-hardening resin has been applied onto the recording layer 12 with a thickness of 5 μm as an adhesive and then hardening the UV-hardening resin.

TABLE 2

| | 8T CN (dB) | 8T CN (dB) | Change in CN |
|---|---|---|---|
| | Untreated | Treated | (dB) |
| First Embodiment | 53.8 | 54.2 | +0.3 |
| Second Embodiment | 54.2 | 54.9 | +0.7 |
| Third Embodiment | 54.2 | 55.1 | +0.9 |
| Fourth Embodiment | 54.0 | 55.8 | +1.8 |
| Fifth Embodiment | 53.0 | 57.4 | +4.4 |
| First Comparative | 53.3 | 53.1 | −0.2 |
| Example | | | |

| | | |
|---|---|---|
| Second Comparative | 51.3 | Could not be measured |
| Example | | |

The light transmitting layers B to D were formed with a thickness of 100 μm by spin coating and then hardening a mixed resin (UV-hardening resin) in which the resin materials given below are mixed with predetermined proportions by weight. The permeability of the light transmitting layers B to D are as given below.

[Resin Materials Used]

| | |
|---|---|
| Resin 1 | ARONIX M-1200 (made by TOAGOSEI |
| | CO., LTD) |
| Resin 2 | EPOXY ESTER 3002A (made by |
| | KYOEISHA CHEMICAL CO., LTD) |
| Resin 3 | LIGHT ESTER HOA (made by KYOEISHA |
| | CHEMICAL CO., LTD) |
| Resin 4 | 1-Hydroxycyclohexylphenylketone |

[Proportions by Weight]

| | |
|---|---|
| Light Transmitting Layer B | Resin 1:Resin 2:Resin 3:Resin 4 = |
| | 40:47:10:3 |
| Light Transmitting Layer C | Resin 1:Resin 2:Resin 3:Resin 4 = |
| | 40:22:35:3 |
| Light Transmitting Layer D | Resin 1:Resin 2:Resin 3:Resin 4 = |
| | 40:10:47:3 |

[Permeability]

| | |
|---|---|
| Light Transmitting Layer B | 70 g/m² · 24 h |
| Light Transmitting Layer C | 202 g/m² · 24 h |
| Light Transmitting Layer D | 260 g/m² · 24 h |

It should be noted that the permeability of the respective layers (substrates) described above were measured using a method of measuring according to JIS Z0208 using PA-102 moisture pervious cups made by TESTER SANGYO CO,. LTD.

In addition, the optical discs of the first to fifth embodiments and the optical discs of the first and second comparative examples were constructed as described below. Here, the respective optical discs were constructed without the hard coat layer 14 of the optical disc 1 described above being formed.

First embodiment: an optical disc was formed using substrate A as the disc substrate 11 and light transmitting layer A as the light transmitting layer 13.

Second embodiment: an optical disc was formed using substrate B as the disc substrate 11 and light transmitting layer A as the light transmitting layer 13.

Third embodiment: an optical disc was formed using substrate A as the disc substrate 11 and light transmitting layer B as the light transmitting layer 13.

Fourth embodiment: an optical disc was formed using substrate B as the disc substrate 11 and light transmitting layer B as the light transmitting layer 13.

Fifth embodiment: an optical disc was formed using substrate B as the disc substrate 11 and light transmitting layer C as the light transmitting layer 13.

First comparative example: an optical disc was formed using substrate A as the disc substrate 11 and light transmitting layer A as the light transmitting layer 13. However, dielectric layers were formed between the disc substrate 11 and the recording layer 12 and between the recording layer 12 and the light transmitting layer 13, so that an optical disc was formed in which the recording layer 12 is sandwiched by a pair of dielectric layers.

Second comparative example: an optical disc was formed using substrate A as the disc substrate 11 and light transmitting layer D as the light transmitting layer 13.

Two each of the seven types of optical discs described above were manufactured and one of each type was left in a high humidity environment (temperature: 25° C., relative humidity: 95% ±2%) for seven days (168 hours). Next, the fourteen optical discs (i.e., the seven optical discs left in the high humidity environment and the seven untreated optical discs) were successively set in an optical recording medium evaluation apparatus DDU1000 (made by PULSTEC INDUSTRIAL CO., LTD) and recording marks that are 8 T long were formed on the respective recording layers 12. It should be noted that when forming the recording marks, the laser beam recording power Pw was gradually raised in stages from 3 mW to 10 mW and recording marks were formed for the respective recording powers. The other recording conditions were set as given below.
Laser beam wavelength: 405 nm
Numerical aperture NA of the objective lens: 0.85
Modulation method: (1,7) RLL
Linear recording velocity: 5.3 m/sec
Channel bit length: 0.12 μm
Channel clock: 66 MHz
Recording method: On-groove recording
Reproduction power: 0.7 mW
Intermediate power: 2.0 mW
Base power: 1.0 mW

Next, using the optical recording medium evaluation apparatus mentioned above, the 8 T-long recording marks recorded on the recording layer 12 were reproduced and the C/N ratio of the reproduction signal was measured. The measurement results are shown in Table 2. It should be noted that an XK180 spectrum analyzer (made by ADVANTEST CORPORATION) was used to measure the C/N ratio. Regarding the reproduction conditions, the reproduction power Pr was set at 0.7 mW. It should be noted that in Table 2, the optical discs that were not left in the high humidity environment are indicated as “Untreated” and the optical discs that were left in the high humidity environment are indicated as “Treated”.

As shown in Table 2, in the optical discs according to the first to fifth embodiments, since the permeabilities of the disc substrate 11 and the light transmitting layer 13 that are formed so as to sandwich the recording layer 12 are in a range of 1 g/m²·24 h to 250 g/m²·24 h, inclusive, the surface of the recording layer 12 is reformed by leaving the discs in the high humidity environment so that the C/N ratio is improved by 0.3 dB to 4.4 dB. Accordingly, it can be understood that the C/N ratio can be improved by manufacturing the optical discs so that the recording layer 12 is sandwiched by layers (in the examples described above, substrates A, B and light transmitting layers A to C) whose permeability is set in a range of 1 g/m²·24 h to 250 g/m²·24 h, inclusive. Also, for the optical discs of the second and fourth embodiments where the permeabilities of both the disc substrate 11 and the light transmitting layer 13 are in the range of 1.5 g/m²·24 h to 250 g/m²·24 h, inclusive, the change in the C/N ratio when the discs are left in the high humidity environment is sufficiently large compared to the optical discs of the first and third embodiments where the permeability of only the light transmitting layer 13 is in the range of 1.5 g/m²·24 h to 250 g/m²·24 h, inclusive. Accordingly, it can be understood that a greater improvement can be made in the C/N ratio by forming not just one but both the disc substrate 11 and the light transmitting layer 13 with permeabilities in the range of 1.5 g/m²·24 h to 250 g/m²·24 h, inclusive.

In addition, in the optical discs of the fourth and fifth embodiments where the permeabilities of both the disc substrate 11 and the light transmitting layer 13 are in the range of 40 g/m²·24 h to 250 g/m²·24 h, inclusive, the changes in the C/N ratio when the discs are left in the high humidity environment become extremely large at +1.8 dB and +4.4 dB. Accordingly, it can be understood that the C/N ratio can be improved more by manufacturing optical discs so that the recording layer 12 is sandwiched by layers (in the examples described above, substrate B and light transmitting layers B and C) whose permeability is set in a range of 40 g/m²·24 h to 250 g/m²·24 h, inclusive. It should be noted that the applicant confirmed that even when the hard coat layer 14 was formed on the respective optical discs of the first to fifth embodiments, the permeability of the multilayer structure of the light transmitting layer 13 and the hard coat layer 14 was in the range of 1 g/m²·24 h to 250 g/m²·24 h, inclusive. The applicant also confirmed that even when the hard coat layer 14 is formed, it is possible to avoid a large drop in the change in the C/N ratio caused by the disc being left in the high humidity environment.

On the other hand, in the optical disc of the first comparative example where the recording layer 12 is sandwiched by dielectric layers with a permeability of 0.08 g/m²·24 h, regardless of whether the disc is left in the high humidity environment, no improvement in the C/N ratio was observed. Accordingly, it can be understood that it is difficult to improve the C/N ratio when the recording layer 12 is sandwiched with layers whose permeability falls below 1 g/m²·24 h. Also, with the optical disc of the second comparative example that uses a light transmitting layer 13 whose permeability is 260 g/m²·24 h, when the disc is left in the high humidity environment, a large amount of moisture permeates through the light transmitting layer 13, which soaks the recording layer 12 and causes delamination. For this reason, it was not possible to measure the C/N ratio for the optical disc of the second comparative example that was left in the high humidity environment. Accordingly, it can be understood that it is difficult to even record and reproduce recording data when the recording layer 12 is sandwiched by a layer whose permeability exceeds 250 g/m²·24 h.

In this way, according to the optical disc 1, by forming at least one out of the disc substrate 11 and the light transmitting layer 13 so that the permeability according to JIS Z0208 is in the range of 1 g/m²·24 h to 250 g/m²·24 h, inclusive, the recording layer 12 can be sufficiently protected by the disc substrate 11 and the light transmitting layer 13 and the C/N ratio can be sufficiently improved by having the recording layer 12 reformed by moisture that permeates through the disc substrate 11 and the light transmitting layer 13 when the disc is left in a high humidity environment. Also, the recording layer 12 differs to a conventional bare optical disc, and when the recording layer 12 is irradiated with the laser beam 20 during the reproduction of recording data, the recording layer 12 rises to a sufficient temperature for deformation or reformation, so that recording marks can be reliably formed.

Also, according to the optical disc 1, by forming the disc substrate 11 and the light transmitting layer 13 so that the permeabilities of both the disc substrate 11 and the light transmitting layer 13 are in the range of 1 g/m²·24 h to 250 g/m²·24 h, inclusive, the C/N ratio can be improved further by having the recording layer 12 sufficiently reformed by moisture that permeates through the disc substrate 11 and the light transmitting layer 13.

In addition, according to the optical disc 1, by constructing the optical disc 1 so that the recording layer 12 is formed between the disc substrate 11 and the light transmitting layer 13, compared to an optical disc with a multilayer structure where the recording layer 12 is sandwiched by dielectric layers or the like, a sputtering apparatus for forming the dielectric layers and a process for forming the dielectric layers or the like can be made unnecessary. Accordingly, it is possible to sufficiently reduce the manufacturing cost of the optical disc 1. In this case, by forming the thickness of the light transmitting layer 13 in a range of 30 μm to 200 μm, inclusive, it is possible to carry out high density recording on the recording layer 12 by emitting a laser beam with a short wavelength (λ) from an objective lens with a large numerical aperture (NA).

In addition, according to the optical disc 1, by forming the disc so that the permeabilities of both the disc substrate 11 and the light transmitting layer 13 are in a range of 40 g/m²·24 h to 250 g/m²·24 h, inclusive, it is possible to improve the C/N ratio further by having the recording layer 12 sufficiently reformed by moisture that has permeated through the disc substrate 11 and the light transmitting layer 13.

Also, according to the optical disc 1, by constructing the disc so that the hard coat layer 14 is formed so as to cover the light transmitting layer 13 and the permeability of the multilayer structure of the light transmitting layer 13 and the hard coat layer 14 is in a range of 1 g/m²·24 h to 250 g/m²·24 h, inclusive, it is possible to have the hard coat layer 14 prevent damage to the optical disc 1 without the permeation of moisture being obstructed by the hard coat layer 14 that is extremely thin. Accordingly, an optical disc 1 that has a high C/N ratio and is also resistant to damage can be provided.

In addition, according to the optical disc 1, by constructing the recording layer 12 of a single layer formed using a recording material that has the two elements Bi and O as main components, the construction becomes simple and the material cost becomes comparatively cheap, so that the manufacturing cost of the optical disc 1 can be sufficiently reduced. Also, since the recording layer 12 can be reformed by the moisture that has permeated through the disc substrate 11 and the light transmitting layer 13, it is possible to provide an optical disc with a favorable C/N ratio.

It should be noted that the present invention is not limited to the construction described above. As one example, although the optical disc 1 (the optical disc of the first to fifth embodiments) that is formed so that the respective permeabilities of both the disc substrate 11 and the light transmitting layer 13 are in a range of 1 g/m²·24 h to 250 g/m²·24 h, inclusive has been described, the present invention is not limited to this, and it is also possible to use a construction where one of the disc substrate 11 and the light transmitting layer 13 has a permeability of below 1 g/m²·24 h. With this construction also, the recording layer 12 can be sufficiently reformed and the C/N ratio improved by leaving the disc in a high humidity environment.

Also, although an example of an optical disc 1 has been described where recording data is recorded and reproduced by irradiating the laser beam 20 on the recording layer 12 from the side of the light transmitting layer 13 that is formed by spin coating or the like, it is also possible to apply the present invention to an optical disc on which recording data is recorded and reproduced by irradiating the laser beam 20 toward the recording layer from the side of the disc substrate that serves as the light transmitting layer. More specifically, the information recording medium according to the present invention also includes an optical disc in which the recording layer is formed between a disc substrate with a thickness of around 1.1 mm as the light transmitting layer and a thin resin layer formed by spin coating or the like, and an optical disc in which the recording layer is formed between a disc substrate that is around 0.6 mm thick as a light transmitting layer and another disc substrate (a so-called “dummy substrate) that is also around 0.6 mm thick. Also, although an example of an optical disc 1 with a single recording layer 12 has been described, it is also possible to apply the present invention to a multilayer information recording medium including a plurality of recording layers that are directly sandwiched by a pair of resin layers (various kinds of resin layers such as injection-molded substrates, resin layers formed by applying a resin material, and resin films). It should be noted that when the present invention is applied to a multilayer information recording medium with N recording layers (where N is a natural number of two or higher), out of the resin layers that contact at least one recording layer out of the first recording layer and N^{th} recording layer in the plurality of recording layers, the permeabilities of the resin layers on the surface layer sides should be in the range of 1 g/m²·24 h to 250 g/m²·24 h. In this case, the “resin layers on the surface layer sides” are the resin layer formed on the opposite side of the first recording layer to the second recording layer and the resin layer formed on the opposite side of the N^{th} recording layer to the (N-1)^{th} recording layer (that is, the outer resin layers of the multilayer information recording medium), and out of these, at least one resin layer should be formed with a permeability in the range stated above. In addition, the present invention can also be applied to a double-sided information recording medium where light transmitting layers are formed on both front and rear surfaces of the information recording medium. In this case, one or a number of recording layers may be present on the front and rear surface sides.

What is claimed is:

1. An information recording medium in which a recording layer is formed so as to be sandwiched by a first resin layer and a second resin layer, and a track pitch is in a range of 0.1 μm to 0.5 μm, inclusive,
wherein at least one resin layer out of the first and second resin layers has a permeability according to JIS Z0208 in a range of 1 g/m²·24 h to 250 g/m²·24 h,inclusive.

2. An information recording medium according to claim 1, wherein both the first and second resin layers have permeabilities in a range of 1 g/m²·24 h to 250 g/m²·24 h, inclusive.

3. An information recording medium according to claim 1, wherein the recording layer is formed between a support substrate made of resin as the first resin layer and a light transmitting layer as the second resin layer.

4. An information recording medium according to claim 1, wherein both the first and second resin layers have permeabilities in a range of 40 g/m²·24 h to 250 g/m²·24 h, inclusive.

5. An information recording medium in which a recording layer is formed so as to be sandwiched by a support substrate made of resin as a first resin layer and a light transmitting layer as a second resin layer, a hard coat layer is formed so as to cover the light transmitting layer, and a track pitch is in a range of 0.1 μm to 0.5 μm, inclusive,
wherein a multilayer structure composed of the light transmitting layer and the hard coat layer has a permeability according to JIS Z0208 in a range of 1 g/m²·24 h to 250 g/m²·24 h, inclusive.

6. An information recording medium according to claim 1,
wherein the recording layer is composed of a single layer formed using a recording material with two elements Bi and O as main components.
